(19) United States
(12) Patent Application Publication
(10) Pub. No.: US 2002/0143804 A1
(43) Pub. Date: Oct. 3, 2002

(54) Electronic filer

(76) Inventor: Jacklyn M. Dowdy, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/824,262

(22) Filed: Apr. 2, 2001

(51) Int. Cl. G06F 15/00

(52) U.S. Cl. 707/500

(57) ABSTRACT

Documents are managed in a document management system using a document management method. An image of a document is generated. At least one keyword is identified in the document image. The at least one keyword is identified by locating keyword fields in the document image and detecting words in the keyword fields. The keyword fields are located by either searching for the keyword fields in a selected location of the document image or detecting a field indicator within the document image and locating the keyword fields relative to the field indicator. The at least one keyword is identified by recognizing characters in the document image. Words are detected from characters recognized in the document image. A document name is generated from the at least one keyword. The document image is stored with the document name.

### FIELD OF THE INVENTION

This invention relates in general to document management and, more particularly, to document conversion from hardcopy to electronic form.

### BACKGROUND OF THE INVENTION

Hardcopy documents are space consuming and difficult to organize compared to digital copies of the documents. Obtaining and organizing digital copies of hardcopy documents is often time consuming.

Conventionally, in order to obtain a digital copy of a hardcopy document, a user scans the document, selects a name for the document, and saves it. The document is either saved as an image or optical character recognition is performed on the document and the document is saved in text form. The user is also responsible for organizing all the digital copies of hardcopy documents.

This conventional system requires a large amount of interaction from a user.

### SUMMARY OF THE INVENTION

A system requiring less user interaction is therefore desirable. According to principles of the present invention, documents are managed in a document management system using a document management method. An image of a document is generated. At least one keyword is identified in the document image. A document name is generated from the at least one keyword. The document image is stored with the document name.

According to further principles of the present invention, the keywords are identified by locating keyword fields in the document image and detecting words in the keyword fields. The keyword fields are located by either searching for the keyword fields in a selected location of the document image or detecting a field indicator within the document image and locating the keyword fields relative to the field indicator. The keywords are identified by recognizing characters in the document image. Words are detected from characters recognized in the document image.

### DESCRIPTION OF THE DRAWINGS

FIG. 1 is a block diagram representing one embodiment of the document management system of the present invention.

FIG. 2 is a flow chart illustrating one embodiment of the document management method of the present invention.

### DETAILED DESCRIPTION OF THE INVENTION

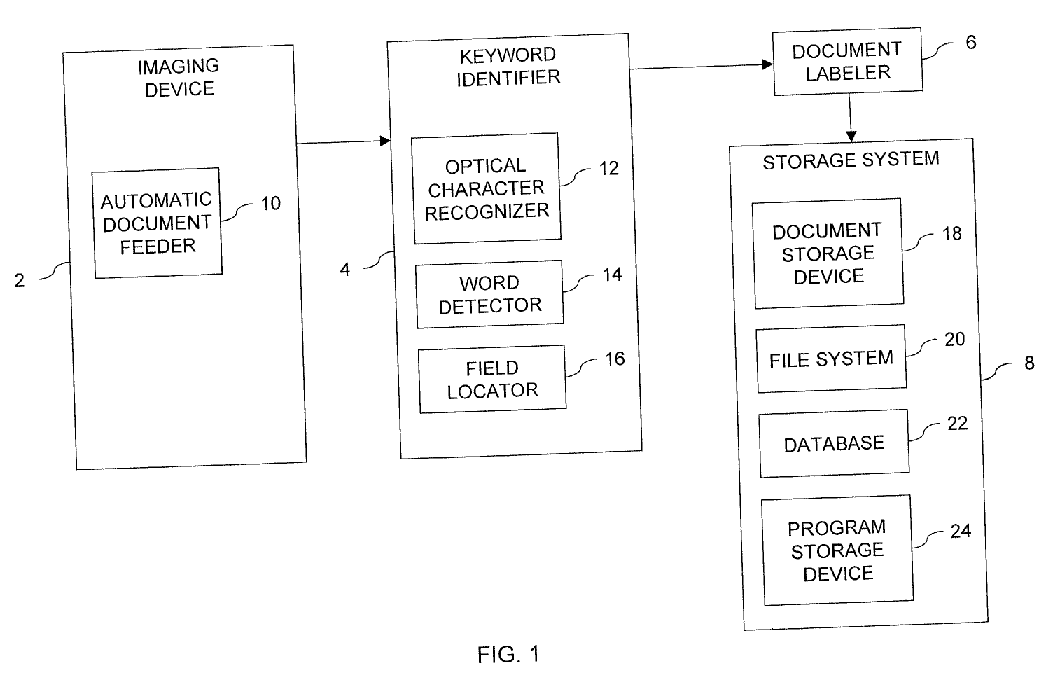

Illustrated in FIG. 1 are an imaging device 2, a keyword identifier 4, a document labeler 6, and a storage system 8. In one embodiment, imaging device 2, keyword identifier 4, document labeler 6, and storage system 8 are separate systems or devices. In an alternative embodiment, imaging device 2, keyword identifier 4, document labeler 6, and storage system 8 are housed in any combination within a single or multiple devices. Keyword identifier 4 and document labeler 6 may be embodied as executable code for execution on a processing device (not shown), such as a general or specific purpose computer.

Imaging device 2 is any device or system configurable to create an electronic image from a hardcopy document. Examples of imaging device 2 include a scanner, a copier, a facsimile machine, and a digital camera. In one embodiment, imaging device 2 includes an automatic document feeder (ADF) 10. ADF 10 is any device for supporting multiple hardcopy document pages and automatically feeding documents to imaging device 2 without user intervention.

Keyword identifier 4 is any device, system, or executable code configurable to identify keywords from an electronic image of a document. Examples of keywords include categories into which a hardcopy document would fall, the sender or author of the document, dates of significance to the document, and key phrases from the body of the document.

In one embodiment, keyword identifier 4 includes an optical character recognizer 12. Optical character recognizer 12 is any device, system, or executable code configurable to recognize typographic characters from an image of a document.

In another embodiment, keyword identifier 4 includes a word detector 14. Word detector 14 is any device, system, or executable code configurable to recognize words from sequences of recognized characters.

In a further embodiment, keyword identifier 4 includes a field locator 16. Field locator 16 is any device, system, or executable code configurable to locate fields from an image of a document.

Document labeler 6 is any device, system, or executable code configurable to generate a name for an image of a document from keywords for the document. Document labeler 6 receives the keywords from keyword identifier 4. In one embodiment, document labeler 6 further assigns the image of the document a location in a file structure based on the keywords.

Storage system 8 is any device or system configurable to store the document image with a document name generated by document labeler 6. Storage system 8 includes a document storage device 18 and a file system 20. File system 20 is any system for filing electronic documents. For example, file system 20 may be a portion of an operating system.

Document storage device 18 is any device for storing an electronic copy of a hardcopy document. Document storage device 18 may be any type of storage media such as magnetic, optical, or electronic storage media. Although depicted as integral to storage system 8, document storage device 18 is alternatively embodied separate from storage system 8 and accessible by storage system 8.

In one embodiment, storage system 8 includes a database 22. Database 22 is any database for storing electronic documents and keywords associated with the documents.

In one embodiment, storage system 8 includes a program storage device 24. Program storage device 24 is any device or system tangibly embodying a program, applet, or instructions executable by a computer for performing the method steps of the present invention. In one embodiment, keyword identifier 4 and document labeler 6 are stored on program storage device 24. Although depicted as integral to storage system 8, program storage device 24 is alternatively embodied separate from storage system 8 and accessible as part of storage system 8.

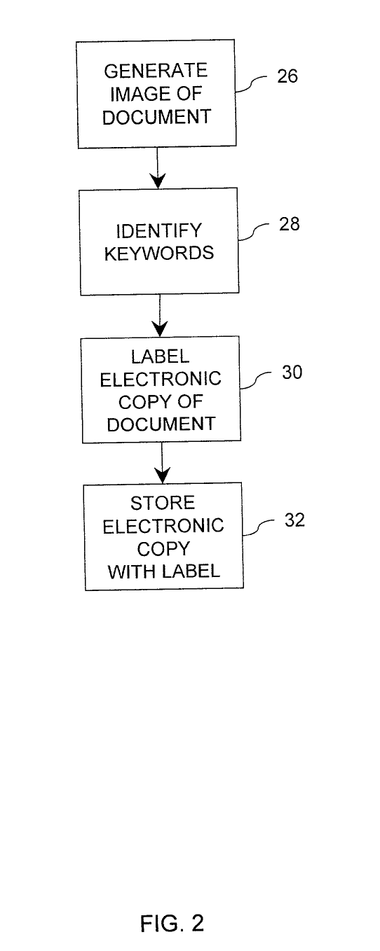

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

An image of a document is generated 26. Keywords are identified 28 in the document image. Keyword identifier 4 identifies 28 the keywords. In one embodiment, the keywords are identified 28 by identifying words in the document. The keywords are identified 28 by recognizing characters in the document image. Words are detected from characters recognized in the document image.

In an alternate embodiment, the keywords are identified 28 by locating keyword fields in the document image and detecting words in the keyword fields. The keyword fields are located by either searching for the keyword fields in a selected location of the document image or detecting a field indicator within the document image and locating the keyword fields relative to the field indicator. For example, a particular graphic image may be used as a field indicator. During keyword identification 28, the particular graphic image is used to indicate the location of the keywords, such as immediately above the particular graphic.

In one embodiment, a label is applied by a user to the document before the image is generated 26. The label may be any type of label, for example, self-adhering paper labels. On the label are the keywords, either applied by the user or preprinted. The label either is applied in a specific location or contains the particular graphic image, depending on the requirements of keyword identifier 4.

A document name or label is generated 30 from the keywords. The document image is stored 32 with the document name. In one embodiment, the document is stored 32 in a file structure based on the identified keywords. In an alternate embodiment, the document name and other keywords are stored in a document database. Storing the document name and keywords in a database provides a user with a useful means for retrieving electronic documents.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A document management system comprising:
(a) an imaging device configured to create an image of a document;
(b) a keyword identifier configured to identify at least one keyword in the document image;
(c) a document labeler configured to generate a document name from the at least one keyword; and,
(d) a storage system configured to store the document image with the document name.

2. The system of claim 1 wherein the keyword identifier includes an optical character recognizer configured to recognize characters in the document image.

3. The system of claim 2 wherein the keyword identifier includes a word detector configured to detect words from characters recognized in the document image.

4. The system of claim 1 wherein the keyword identifier includes a field locator configured to locate keyword fields in the document image.

5. The system of claim 1 wherein the storage system includes a document storage device.

6. The system of claim 1 wherein the storage system includes a file system.

7. The system of claim 1 wherein the storage system includes a database.

8. A document management method comprising:
(a) creating an image of a document;
(b) identifying at least one keyword in the document image;
(c) generating a document name from the at least one keyword; and,
(d) storing the document image with the document name.

9. The method of claim 8 wherein identifying the at least one keyword includes recognizing characters in the document image.

10. The method of claim 9 wherein identifying the at least one keyword includes detecting words from characters recognized in the document image.

11. The method of claim 8 wherein identifying the at least one keyword includes locating keyword fields in the document image.

12. The method of claim 11 wherein locating keyword fields includes:
(a) detecting a field indicator within the document image; and,
(b) locating the keyword fields relative to the field indicator.

13. The method of claim 11 wherein locating keyword fields includes searching for the keyword fields in a selected location of the document image.

14. The method of claim 8 wherein storing the document image includes storing the document image in a database.

15. A program storage device readable by a computer, tangibly embodying a program, applet, or instructions executable by the computer to perform method steps for managing documents, the method steps comprising:
(a) creating an image of a document;
(b) identifying at least one keyword in the document image;
(c) generating a document name from the at least one keyword; and,
(d) storing the document image with the document name.

16. The program storage device of claim 15 wherein the method step of identifying the at least one keyword includes recognizing characters in the document image.

17. The program storage device of claim 16 identifying the at least one keyword includes detecting words from characters recognized in the document image.

18. The program storage device of claim 15 wherein the method step of identifying the at least one keyword includes locating keyword fields in the document image.

19. The program storage device of claim 18 wherein the method step of locating keyword fields includes:
(a) detecting a field indicator within the document image; and,
(b) locating the keyword fields relative to the field indicator.

20. The program storage device of claim 18 wherein the method step of locating keyword fields includes searching for the keyword fields in a selected location of the document image.
